(19) United States
(12) Patent Application Publication
(10) Pub. No.: US 2026/0307675 A1
(43) Pub. Date: Oct. 8, 2026

(54) DATA SCHEDULING METHOD AND VEHICLE USING SAME

(71) Applicants: HYUNDAI MOTOR COMPANY, Seoul (KR); KIA CORPORATION, Seoul (KR)

(72) Inventors: Yu Ho CHOI, Hwaseong-si (KR); Jae Hyeon PARK, Hwaseong-si (KR); Jae Sung LEE, Hwaseong-si (KR)

(21) Appl. No.: 19/637,004

(22) Filed: Apr. 2, 2026

(30) Foreign Application Priority Data
Apr. 3, 2025 (KR) 10-2025-0043332

(51) Int. Cl. B60W 60/00; B60W 30/095; G06V 20/58

(52) U.S. Cl. CPC B60W 60/001; B60W 30/095; G06V 20/58

(57) ABSTRACT

Disclosed herein a data scheduling method and vehicle using same. The method includes: asynchronously performing parallel processing on a plurality of sensor data detected a surrounding environment of a vehicle by a first processor for preprocessing, asynchronously performing parallel processing on the plurality of preprocessed sensor data by a second processor for object recognition; and synchronously processing perception data output from the second processor.

### CROSS-REFERENCE TO RELATED APPLICATION

This application claims the benefit of priority to Korean Patent Application No. 10-2025-0043332, filed in the Korean Intellectual Property Office on Apr. 3, 2025, the disclosure of which is incorporated herein by reference in its entirety.

### TECHNICAL FIELD

The present disclosure relates to a data scheduling method and a vehicle using the same, and more specifically, the present disclosure relates to a data scheduling method and vehicle that improve processing performance of multimodal data and realize resource optimization.

### BACKGROUND

The matters described in this Background section are only for enhancement of understanding of the background of the disclosure, and should not be taken as acknowledgment that they correspond to prior art already known to those skilled in the art.

Autonomous driving technology may be one of various functions, and applied so that the vehicle may recognize the surrounding environment, estimate a driving route, and control itself.

The learned model for autonomous driving may have a high complexity to meet the high level of perception performance required by autonomous driving. An architecture that integrates and processes data collected from a plurality of homogeneous sensors or heterogeneous sensors into a single learning model is considered. The single learning model may be referred to as a multimodal model. This may improve system efficiency by fusing sensor data with different characteristics in a single model.

However, even if an architecture of a multimodal model with improved computational performance is designed, performance delays may be caused in a series of processes executed in a control system of a vehicle driving the model, such as preprocessing, postprocessing, and the like.

### SUMMARY

A various examples of the present disclosure is to provide a data scheduling method and vehicle that improve processing performance of multimodal data and realize resource optimization.

The various examples to be achieved in the present disclosure are not limited to the above-mentioned technical problems, and other technical problems not mentioned will be clearly understood by a person skilled in the art from the following description.

According to the present disclosure, a method performed by a vehicle may comprise obtaining, by a plurality of sensors of the vehicle, sensor data associated with a surrounding environment of the vehicle, asynchronously performing parallel preprocessing on pieces of the sensor data, asynchronously performing parallel object-recognition processing on the preprocessed pieces of the sensor data to generate perception data, synchronously processing the perception data, outputting a signal associated with the synchronously processed perception data, and controlling, based on the signal, autonomous driving of the vehicle. The method may further comprise applying the preprocessed pieces of the sensor data to a trained learning model to perform the object-recognition processing.

The asynchronously performing parallel preprocessing on pieces of the sensor data may comprise determining whether the preprocessing on the pieces of the sensor data allows asynchronous parallel execution and, based on a determination that the preprocessing on the pieces of the sensor data allows asynchronous parallel execution, performing the asynchronous parallel preprocessing on the pieces of the sensor data. The plurality of sensors may comprise at least a camera and a heterogeneous sensor different from the camera, and the sensor data may comprise image data generated from the camera and heterogeneous data generated from the heterogeneous sensor.

The synchronously processing the perception data may comprise synchronously processing the perception data to generate a path estimation associated with the vehicle and a control command for the vehicle. The synchronously processing the perception data may be performed by at least one first processor of the vehicle that performed the asynchronous parallel preprocessing, and the asynchronously performing parallel object-recognition processing may be performed by at least one second processor of the vehicle. The method may further comprise, before the synchronously processing the perception data, asynchronously performing parallel postprocessing on the perception data.

The method may further comprise, before the asynchronous parallel processing, selecting the pieces of the sensor data, wherein the pieces of the sensor data are selected based on an estimated path of the vehicle, and wherein the estimated path is determined based on preceding sensor data of the plurality of sensors. The method may further comprise, before the asynchronous parallel processing, performing interface processing on the pieces of the sensor data and performing parallel processing on the interface processed pieces of the sensor data.

According to the present disclosure, a vehicle may comprise a plurality of sensors configured to obtain sensor data associated with a surrounding environment of the vehicle and a memory storing at least one instruction that, when executed by at least one processor, is configured to cause the vehicle to asynchronously perform, using a first processor of the vehicle, parallel preprocessing on pieces of the sensor data, asynchronously perform, using a second processor of the vehicle, parallel object-recognition processing on the preprocessed pieces of the sensor data to generate perception data, synchronously process the perception data, output a signal associated with the synchronously processed perception data, and control, based on the signal, autonomous driving of the vehicle.

The at least one instruction, when executed by the at least one processor, may be configured to cause the vehicle to execute a learning model for performing the object-recognition processing. The at least one instruction, when executed by the at least one processor, may be configured to cause the vehicle to determine whether the preprocessing on the pieces of the sensor data allows asynchronous parallel execution and, based on a determination that the preprocessing on the pieces of the sensor data allows asynchronous parallel execution, perform the asynchronous parallel preprocessing on the pieces of the sensor data. The plurality of sensors may comprise at least a camera and a heterogeneous sensor different from the camera, and the sensor data may comprise image data generated from the camera and heterogeneous data generated from the heterogeneous sensor.

The at least one instruction, when executed by the at least one processor, may be configured to cause the vehicle to synchronously process the perception data to generate a path estimation associated with the vehicle and a control command for the vehicle. The first processor may be configured to synchronously process the perception data. The at least one instruction, when executed by the at least one processor, may be configured to cause the vehicle to, before synchronously processing the perception data, asynchronously perform parallel postprocessing on the perception data.

The at least one instruction, when executed by the at least one processor, may be configured to cause the vehicle to, before asynchronously performing parallel preprocessing on the pieces of the sensor data, select the pieces of the sensor data, wherein the pieces of the sensor data are selected based on an estimated path of the vehicle, and wherein the estimated path is determined based on preceding sensor data of the plurality of sensors. The at least one instruction, when executed by the at least one processor, may be configured to cause the vehicle to, before asynchronously performing parallel preprocessing, perform interface processing on the pieces of the sensor data and perform parallel processing on the interface processed pieces of the sensor data.

According to the present disclosure, a vehicle may comprise a plurality of sensors configured to obtain sensor data associated with a surrounding environment of the vehicle and controller circuitry configured to cause the vehicle to estimate, based on the sensor data, a predicted driving path of the vehicle, select, based on the estimated driving path, pieces of the sensor data, schedule the selected pieces of the sensor data for earlier processing than remaining pieces of the sensor data, process the selected pieces of the sensor data in parallel when processing of different pieces of the sensor data does not depend on one another, output a signal indicating the processed pieces of the sensor data, and control, based on the signal, autonomous driving of the vehicle.

The controller circuitry may be further configured to schedule, based on an expected driving maneuver of the vehicle, the selected pieces of the sensor data for earlier processing. The controller circuitry may be further configured to schedule the selected pieces of the sensor data for earlier processing based on an order in which interface processing of the pieces of the sensor data is completed.

The features briefly summarized above for this disclosure are only examples of the detailed description of the disclosure which follow and are not intended to limit the scope of the disclosure.

### BRIEF DESCRIPTION OF THE DRAWINGS

The above and other objects, features and advantages of the present disclosure will become more apparent to those of ordinary skill in the art by describing one or more example examples thereof in detail with reference to the accompanying drawings, in which:

FIG. 1 shows an example that a vehicle communicates with another device to transmit and receive data.

FIG. 2 shows an example of modules that configures a vehicle.

FIG. 3 shows an example of modules that configures a controller.

FIG. 4 shows an example of modules that configures a server.

FIG. 5 shows an example of a data scheduling method.

FIG. 6 shows an example of sensor data selected based on an estimation path.

FIG. 7 shows an example of data processing according to data scheduling in the present disclosure.

FIG. 8 shows an example of data processing according to synchronous scheduling of data.

FIG. 9 shows an example computing system.

### DETAILED DESCRIPTION

Hereinafter, examples of the present disclosure will be described in detail with reference to the accompanying drawings so that those skilled in the art may easily implement the present disclosure. However, the present disclosure may be implemented in various ways and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all combinations of the listed items. For example, "at least one of A or B" may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on the feature of early processing of high-relevance sensor data (e.g., prioritizing front-camera data before a right turn, prioritizing rear-camera data during reverse movement, or prioritizing right-side radar data when merging), the vehicle may activate specific autonomous-driving functions in advance. For example, early processed perception data may trigger earlier braking assistance, lane-keeping support, or adaptive steering adjustments before lower-priority sensor data is fully processed. The vehicle control may include various operational controls associated with the vehicle (e.g., autonomous driving control, sensor control, braking control, braking time control, acceleration control, acceleration change rate control, alarm timing control, forward collision warning time control, etc.).One or more auxiliary devices (e.g., engine brake, exhaust brake, hydraulic retarder, electric retarder, regenerative brake, etc.) may also be controlled based on the feature of early processing of high-relevance sensor data. For example, when early processed front-camera or radar data predicts a sudden slowdown ahead or an upcoming downhill slope, the vehicle may pre-activate an engine brake, hydraulic retarder, or regenerative brake to stabilize deceleration and improve energy recovery.

One or more communication devices (e.g., a modem, a network adapter, a radio transceiver, an antenna, etc., capable of communicating via Ethernet, Wi-Fi, NFC, Bluetooth, LTE, 5G NR, V2X, etc.) may also be controlled based on the feature of early processing of high-relevance sensor data. For example, when early processed sensor data indicates an upcoming lane merge or dense traffic area, the vehicle may pre-activate V2X broadcasting to share position and intent information, or boost 5G NR connectivity to receive high-precision map updates before executing the maneuver. Minimum risk maneuver (MRM) operation(s) may also be controlled based on the feature of early processing of high-relevance sensor data. For example, when early processed front-camera or radar data detects a stalled vehicle ahead or drifting out of lane boundaries, the vehicle may pre-activate an MRM by slowing down, steering toward a safe shoulder, or activating hazard lights before lower-priority sensor data is processed. A minimal risk maneuvering operation (e.g., a minimal risk maneuver, a minimum risk maneuver) may be a maneuvering operation of a vehicle to minimize (e.g., reduce) a risk of collision with surrounding vehicles to reach a lowered (e.g., minimum) risk state. A minimal risk maneuver may be activated during autonomous driving when a driver is unable to respond to a request to intervene, and during the minimal risk maneuver one or more processors of the vehicle may control a driving operation of the vehicle for a set period of time.

Biased driving operation(s) may also be controlled based on the feature of early processing of high-relevance sensor data. For example, when early-processed front- or side-camera data detects a nearby large vehicle or an obstacle encroaching on a lane boundary, the driving control apparatus may pre-adjust the target lateral distance to bias the vehicle slightly toward the safer side of the lane before the rest of the sensor data is processed. A driving control apparatus may perform a biased driving control by controlling the vehicle to drive in a lane while maintaining a lateral distance between the vehicle center and the lane center. For example, the apparatus may control the vehicle to stay in the lane but not strictly at the center. The apparatus may determine a biased target lateral distance, such as an intentionally adjusted lateral offset from a reference point (e.g., lane center or the position of an adjacent vehicle) to improve stability or safety. For example, during a lane change, the system may bias the lateral distance to maintain a safer gap from adjacent vehicles based on factors such as vehicle speed, road conditions, or detected obstacles. One or more sensors (e.g., IMU sensors, cameras, LIDAR, RADAR, blind-spot monitoring sensors, lane-departure warning sensors, parking sensors, light sensors, rain sensors, etc.) may also be controlled based on the feature of early processing of high-relevance sensor data. For example, when early-processed front-camera or radar data detects heavy rain, fog, or an obstacle zone, the vehicle may pre-activate a rain sensor’s high-sensitivity mode, increase camera exposure, or trigger LIDAR high-frequency scanning to improve perception before lower-priority sensor data is processed. An operation control for autonomous driving may include various driving controls by the vehicle control device (e.g., acceleration, deceleration, steering, gear shifting, braking, traction control, stability control, cruise control, lane-keeping assist, collision-avoidance control, emergency braking assistance, traffic-sign recognition, or adaptive headlight control).An autonomous driving level and/or autonomous driving activation/deactivation may also be controlled based on the feature of early processing of high-relevance sensor data. For example, when early-processed front-camera or driver-monitoring-sensor data detects that the driver is distracted, drowsy, or looking away from the road, the driving control apparatus may pre-adjust the autonomous driving level by increasing required user attentiveness (e.g., requiring hands-on-wheel or eyes-forward checks more frequently) or may pre-emptively deactivate autonomous driving if lane markings or obstacles detected early make continued autonomy unsafe. In another example, when early processed sensor data indicates that visibility is poor or the road layout is complex, the system may automatically raise the required attentiveness level or disable certain in-vehicle video content on the display. In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

According to the present disclosure, a vehicle may improve the efficiency of processing large amounts of sensor data by selecting and scheduling sensor data that is most important for an upcoming driving movement. The vehicle may include a plurality of sensors, such as cameras, radar sensors, and positioning sensors, and these sensors may generate substantial amounts of data during driving. Because processing all the sensor data sequentially may cause delays, the present disclosure provides a technique in which the vehicle first estimates a driving path and then identifies sensor data associated with sensors that are most relevant to the estimated path. For example, when the estimated driving path indicates a right turn, sensor data acquired from a front camera and a right-side camera may be processed with higher priority. In addition, the vehicle may perform certain processing steps on the selected sensor data in parallel, rather than waiting for each step to complete sequentially. By prioritizing and scheduling the selected sensor data in this manner, the vehicle may reduce processing delays, improve perception performance, and generate timely control decisions based on sensor data that is most relevant to the driving situation.

Hereinafter, examples of the present disclosure will be described with reference to the accompanying drawings.

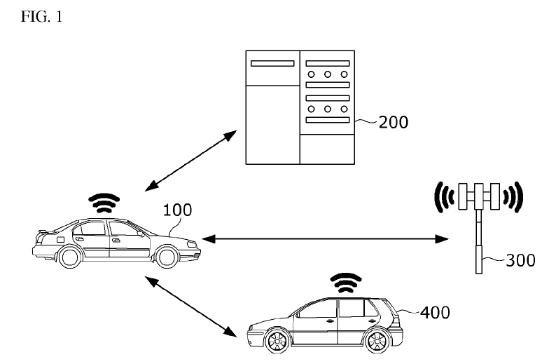

Hereinafter, with reference to FIGS. 1-3, a vehicle that performs data scheduling in a controller that performs processing related to control of the vehicle will be described.

FIG. 1 shows an example that a vehicle communicates with another device to transmit and receive data.

Referring to FIG. 1, a vehicle 100 may be driven on an electric energy or fossil energy basis. In the case of electric energy, the vehicle 100 may employ, for example, a pure battery-based vehicle driven only by a high-voltage battery or a gas-based fuel cell as an energy source. In addition, the fuel cell may utilize various forms of gas capable of generating electrical energy, and the gas may be filled into the vehicle 100, for example, in a liquefied state. Here, the gas may be, for example, hydrogen. However, various gases are applicable without being limited thereto (e.g., compressed natural gas, ammonia-based hydrogen carriers, or synthetic e-fuels, etc.). In the case of fossil energy, the vehicle 100 may be driven based on a fuel, such as gasoline, diesel, or liquefied gas, and may be equipped with an internal combustion engine that drives an actuator 114 by combustion of the fuel. The engine may be included in a power source portion 112 in terms of providing a driving rotational force of a wheel. As another example, the vehicle 100 may selectively utilize the energy of a fossil energy-based internal combustion engine and an electric battery to drive the actuator 114, which may be a hybrid type of vehicle (e.g., parallel hybrid, series hybrid, or plug-in hybrid, etc.).

The vehicle 100 may refer to a device capable of moving. The vehicle 100 is a ground vehicle driving on the ground, and may be a conventional passenger or commercial vehicle, a Purpose-Built Vehicle (PBV), or the like. The vehicle 100 may be a four-wheeled vehicle, such as a passenger car, an SUV, a small truck, or may be a vehicle with more than four wheels, such as a bus, a large truck, a container transport vehicle, a heavy-equipment vehicle, or the like (e.g., mining haulers, fire engines, or airport service vehicles, etc.). The vehicle 100 may be a robot in a broad sense, such as a moving means, and the robot may be moved using wheels, tracks, or other moving modules (e.g., articulated robotic arms on mobile bases, tracked delivery robots, or warehouse AGVs, etc.).

The vehicle 100 may be controlled and driven by manual driving or autonomous driving due to the driving of a user. The autonomous driving may be implemented as semi-autonomous driving or fully autonomous driving. The fully autonomous driving may be provided with autonomous movement in which a controller 118 of the vehicle 100 fully controls operations of the vehicle 100 without user intervention, even if the driving situation is uncertain. The semi-autonomous driving may be provided in an autonomous movement in which driver intervention is required according to a specific driving situation (e.g., construction zones, unmarked roads, or severe weather, etc.). The semi-autonomous driving may be implemented such that the controller 118 switches control to the user while deactivating autonomous driving upon the occurrence of the situation, thereby causing the user to perform manual driving. According to the level of autonomous driving defined in the American Society of Automotive Engineers SAE, the semi-autonomous driving corresponds to autonomous driving levels 1 to 4, and the fully autonomous driving may correspond to level 5 (e.g., full-route planning, complex urban navigation, or emergency-handling without user input, etc.).

On the other hand, the vehicle 100 may communicate with other devices 200, 300 or another vehicle 400. Other devices may include, for example, a server 200 that supports various controls, state management, and driving of the vehicle 100, an ITS device 300 that receives information from an intelligent transportation system (ITS), various types of user devices, and the like (e.g., smartphones, wearable devices, or in-vehicle tablets, etc.). The server 200 is, for example, an external device operated by a vehicle manufacturer or provided to service a driving support function and may receive connected data of the vehicle 100 or transmit data necessary for manual and autonomous driving. The server 200 may transmit various information and software modules used for control of the vehicle 100 to the vehicle 100 in response to requests and data transmitted from the vehicle 100 and a user device, to support driving of the vehicle 100 and various services (e.g., map updates, route optimization, or over-the-air diagnostics, etc.).

The ITS device 300 is, for example, a roadside base station (RSU), and the ITS device 300 may interchange vehicle recognition data, driving control and state data, environment data around the vehicle, map data, and the like through V2I with the vehicle 100 to assist the user's driving of the vehicle or support autonomous driving of the vehicle 100 (e.g., traffic-signal timing, lane-closure information, or pedestrian-presence alerts, etc.). The vehicle 100 may support manual driving or autonomous driving by interchanging the above-listed data through V2V with the other vehicle 400 (e.g., cooperative braking, platooning, or collision-avoidance signaling, etc.).

The vehicle 100 may communicate with other vehicles or other devices based on cellular communication, Wireless Access in Vehicular Environment (WAVE) communication, Dedicated Short Range Communication (DSRC) or near field communication, or other communication schemes (e.g., Bluetooth LE, UWB, or mesh networking, etc.).

For example, the vehicle 100 may use a communication network such as LTE or 5G, a WiFi communication network, a WAVE communication network, or the like as a cellular communication network for communication with the server 200, the ITS device 300, or the other vehicle 400 (e.g., C-V2X, IEEE 802.11p, or mmWave links, etc.). As another example, a DSRC or the like used in the vehicle 100 may be used for communication between vehicles. A communication manner between the vehicle 100, the server 200, the ITS device 300, another vehicle 400, and a user device is not limited to the foregoing example.

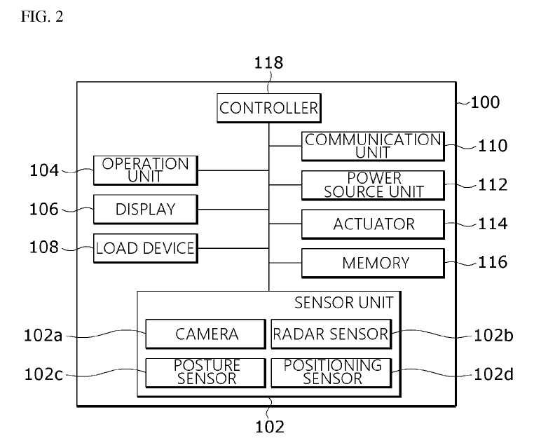

FIG. 2 shows an example of modules that configures a vehicle.

The vehicle 100 may include a sensor unit 102, an operation unit 104, a display 106, a load device 108, and a communication unit 110.

The sensor unit 102 may include various types of sensors for sensing various states and situations occurring in an external surrounding environment, an internal system, a user operation, and a boarding space of the vehicle 100 (e.g., cabin occupancy, door-open states, or driver-gesture inputs, etc.).

Specifically, the sensor unit 102 may include an externally oriented camera 102a, a radar sensor 102b, and the like so as to recognize dynamic and static objects existing in the periphery of the vehicle 100 (e.g., vehicles, pedestrians, road signs, or lane markings, etc.).

The camera 102a may recognize an external object as an image during use of the vehicle 100, generate image data, and transmit the image data to the controller 118. The at least one camera 102amay be mounted at a specific site of the vehicle 100, such as a front site, a rear site, or a lateral site of the vehicle 100 (e.g., left mirror housing, rear spoiler, or bumper grille, etc.). When a plurality of cameras 102aare mounted on each site, it may be referred to as a multi-camera in the present disclosure. The image data obtained by the plurality of cameras 102a may be referred to as multi-view image data. Although not shown, the sensor unit 102 may further include a camera directed toward the interior of the vehicle 100 (e.g., a driver-monitoring camera or rear-seat passenger camera, etc.).

The radar sensor 102b may emit radio waves of a specific frequency around the vehicle 100 to generate radar data through the radio waves reflected from an external object in order to understand the presence and relative distance, velocity, direction, etc. of the external object (e.g., approaching vehicles, cross-traffic, or moving obstacles, etc.). In the present disclosure, the radar sensor 102brecognizes an object in a manner different from that of the camera 102a and thus may be a type of heterogeneous sensor different from the camera 102a.

In the present disclosure, it is illustrated that a lidar sensor (not shown) is not mounted, but in another example, the lidar sensor may be mounted on the vehicle 100. The lidar sensor may generate and transmit point cloud data as recognized data of the external object to the processor to generate three-dimensional spatial information identifying at least a shape of an external object (e.g., vehicle outlines, curb geometry, or roadside vegetation, etc.). The lidar sensor may be a type of heterogeneous sensor different from the camera 102a.

The sensor unit 102 may include a posture sensor 102c. The posture sensor 102cmay detect, for example, three-axis states of the vehicle 100, such as yaw, pitch, and roll, and output various pose states of the vehicle based on the factors described above. The posture sensor may be configured, for example, as an IMU sensor, a gyro sensor, or the like (e.g., accelerometers, magnetometers, or fused inertial modules, etc.). The controller 118 may generate pose data based on the pose state.

In addition, the sensor unit 102 may include a positioning sensor 102dfor confirming the position of the vehicle 100. The positioning sensor 102dis, for example, but not limited to, a GPS sensor or a GNSS sensor (e.g., multi-band GNSS, RTK GNSS, or differential GPS, etc.).

In addition, although not shown in FIG. 1, the sensor unit 102 may include a brake sensor and a wheel sensor. The brake sensor detects a braking degree of the brake, and the wheel sensor may detect, for example, a wheel speed, a wheel rotation angle, and a wheel rotation angular speed of the wheel (e.g., via ABS sensors, Hall-effect sensors, or optical encoders, etc.). The present disclosure mainly describes the sensors of the sensor unit 102 referred to in the description of the example, and may further include sensors that sense various situations not listed therein (e.g., rain sensors, temperature sensors, or cabin CO₂ sensors, etc.).

The operation unit 104 may be configured as a module for a user to steer for driving. For example, the operation unit 104 may be a steering wheel for manual driving, an automatic or manual transmission actuator, an accelerator pedal, a brake pedal, a gear transmission, or the like (e.g., paddle shifters, rotary shifters, or electronic brake switches, etc.). The operation unit 104 may further include an interface for using, releasing, and selecting a detailed function of the autonomous driving mode requested from the user, so that the user uses the autonomous driving function. The operation unit 104 may be configured with, for example, a hard type interface provided at a predetermined position inside the vehicle 100, or a soft type interface that is touchable on the display 106, in order to receive various requests related to autonomous driving (e.g., lane-change requests, parking-assist activation, or speed adjustments, etc.).

The display 106 may function as a user interface. The display 106 may be displayed by the controller 118 to output an operation state of the vehicle 100, a control state, path/traffic information, remaining energy information, content requested by the driver, and the like (e.g., infotainment media, navigation prompts, or ADAS alerts, etc.). In addition, the display 106 may be configured with a touch screen on which driver input is detectable to receive a driver's request instructing the controller 118 (e.g., map zoom, destination entry, or cabin-control inputs, etc.).

The communication unit 110 may support mutual communication with the server 200, the ITS device 300, the surrounding vehicle 400 and the like. The communication unit 110 may include, for example, a module that processes cellular communication, WAVE, DSRC communication, and the like (e.g., 5G NR-V2X modems, IEEE 802.11p modules, or Bluetooth-based short-range units, etc.). In the present disclosure, a transmission/reception unit 116 may transmit data generated or stored during driving to the server 200 in a signal form, and receive data and a software module transmitted from the server 200 as a specific type of signal (e.g., OTA updates, firmware patches, or hazard notifications, etc.).

The communication unit 110 may support communication for transmitting or receiving signals related to data, control, commands, and requests between the components of FIG. 2. The component may be an instrument or module referred to as 102-118 illustrated in FIG. 2. The communication unit 110 may transmit a signal transmitted between components, that is, a signal related to data, control, command, and request, to a communication bus by using, for example, controller area network (CAN) communication, and transmit the signal to a specific component. Data, controls, commands, and requests transmitted via CAN communication may be referred to as CAN data (e.g., steering-angle data, brake-pressure signals, or powertrain commands, etc.).

The communication unit 110 may support communication with an electronic device carried by a passenger inside the vehicle 100 (e.g., smartphones, tablets, or wearable devices, etc.). In the present disclosure, the vehicle 100 may transmit and receive data utilized in the method according to the present disclosure to and from the outside through the communication unit 110.

In addition, the vehicle 100 may include the power source unit 112 and the actuator 114.

The power source unit 112 may generate and supply power and electric power to be used for a driving power system and a non-driving power system such as the actuator 114. The non-driving power system may be, for example, but not limited to, the sensor unit 102, the operation unit 104, the display 106, the load device 108, the communication unit 110, and the like, and may include various components that implement sensing, interface, communication, and convenience functions except for components directly involved in driving operations (e.g., infotainment modules, HVAC systems, or lighting controllers, etc.).

When the vehicle 100 is driven on an electrical energy basis, the power source unit 112 may, for example, be configured with, an electrical battery charged from the outside, or may be configured with a combination of an electrical battery and a fuel cell for charging the battery (e.g., a hydrogen fuel cell stack, a methanol reforming unit, or solid-oxide auxiliary cells, etc.). In the case of a combination of an electric battery and a fuel cell, the power source unit 112 may include a tank that stores a material used to generate power of the fuel cell, such as liquefied hydrogen (e.g., cryogenic hydrogen, compressed hydrogen, or metal-hydride-stored hydrogen, etc.). When the vehicle 100 is driven on a fossil energy basis, the power source unit 112 may be configured as an internal combustion engine. In addition, when the vehicle 100 is of a hybrid type, the power source unit 112 may be provided by a combination of an internal combustion engine and an electric battery (e.g., mild hybrid, full hybrid, or plug-in hybrid, etc.).

The actuator 114 includes at least one module that implements a driving operation and may execute the driving operation based on a signal according to a user request from the operation unit 104 or a request of the controller 118. The signal according to the request may be associated with at least one of a longitudinal control such as acceleration or deceleration, a lateral control such as steering, a gear shift, for example (e.g., forward-reverse selection, automated parking shifts, or downshift requests, etc.). Here, the gear shift may be handled by the request of a manual driving user using a gear shifter or the controller 118 in autonomous driving.

The actuator 114 may include a wheel drive unit, a mechanical component and an electronic module for implementing a driving operation in the wheel drive unit, to perform a driving operation according to a command of the controller 118 by a user's manual operation or autonomous driving. When the vehicle 100 is operated on an electrical energy basis, it may include an assembly for transmitting the requested driving operation to the wheel drive unit (e.g., an inverter module, reduction gear set, or motor-control assembly, etc.). When the vehicle 100 is operated on a fossil energy basis, the actuator 114 may include a transmission, or a gear module that transmits the power of the internal combustion engine.

The wheel drive unit may include a plurality of wheels, a driving force generation module for generating a driving force and applying or transmitting the driving force to the wheels, a braking module for decelerating driving of the wheels, and a steering module for realizing lateral control of the wheels (e.g., rack-and-pinion steering, steer-by-wire units, or torque-vectoring systems, etc.). When the vehicle 100 is driven on an electrical energy basis, the driving force generation module may be configured with a motor assembly that generates a driving force on the basis of power output from an electrical battery (e.g., PMSM motors, induction motors, or hub motors, etc.). When the vehicle 100 is driven on a fossil energy basis, the driving force generation module may be an engine or a transmission assembly. The braking module of the electric-based vehicle 100 may further have a regenerative braking function (e.g., blended braking, coasting regeneration, or pedal-lift regeneration, etc.).

In addition, the vehicle 100 may include a memory 116 and the controller 118.

The memory 116 may store applications and various data for control of the vehicle 100 to load the applications or read and write data at the request of the controller 118 (e.g., map data, perception logs, or over-the-air configuration files, etc.). The application may be executed by the controller 118 embedding at least one controller that performs a particular function.

In the present disclosure, the memory 116 may hold an application that performs scheduling for processing of a plurality of sensor data detected in the sensor unit 102 and control of the vehicle 100. Specifically, the application may be software that performs scheduling of a plurality of sensor data input to the controller 118, establishes a path (or an estimated path or a driving path) of the vehicle 100 by recognizing an environment around the vehicle 100, and controls the vehicle 100 based on the path. The plurality of sensor data may include, for example, a plurality of image data generated for each multi-camera. As another example, the plurality of sensor data may include image data of the camera 102aand heterogeneous data of a heterogeneous sensor (e.g., a radar sensor, a lidar sensor). The plurality of sensor data is not limited to the above-described example and may include sensor data obtained from at least one of different homogeneous sensors and heterogeneous sensors (e.g., radar returns, lidar point clouds, or ultrasonic distance data, etc.).

The controller 118 may perform overall control of the vehicle 100. The controller 118 may be configured to execute applications and instructions stored in the memory 116.

The controller 118 may generate signals related to control for components of the vehicle 100 in response to control requests in manual driving and autonomous driving (e.g., speed commands, steering torque requests, or actuator-health checks, etc.). In the present disclosure, the controller 118 is exemplified as an autonomous driving controller, and the autonomous driving controller may be mounted on, for example, an Electric Control Unit (ECU). Although the present disclosure illustrates an autonomous driving controller, the vehicle 100 may include various controllers. For example, an Motor Control Unit (MCU), a Transmission Control Unit (TCU), a Battery Management System (BMS), an autonomous driving controller, an air conditioning controller, an Electric Drive Control Unit (EDCU), a vehicle communication network controller, and the like may be provided in the vehicle 100 (e.g., domain controllers, zonal controllers, or redundant safety controllers, etc.).

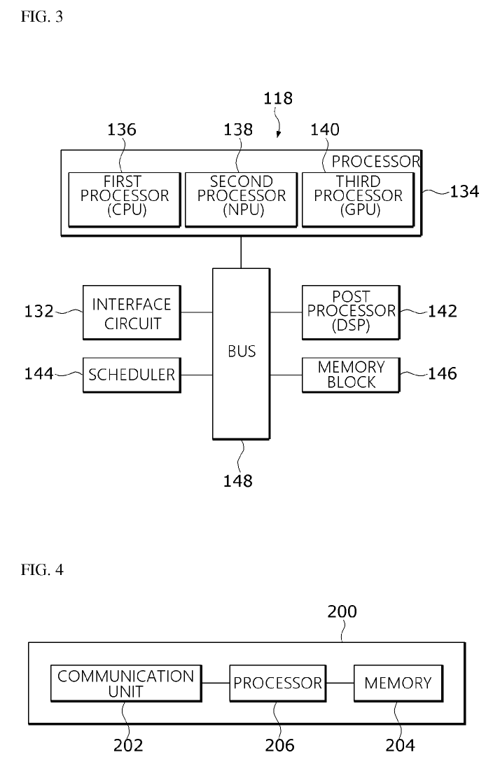

The controller 118 may be implemented, for example, as a System on Chip (SoC). The controller 118 includes modules having various functions, and may include an interface circuit 132, a processor 134, a postprocessor 142, a scheduler 144, and a memory block 146, as illustrated in FIG. 3. FIG. 3 shows an example of modules that configure a controller. A bus 148 may be used to communicate data between the components described above (e.g., high-speed internal buses, shared memory links, or PCI-Express-type interconnects, etc.). The modules described above are exemplary, and the controller 118 may further include other modules.

The interface circuit 132 may transmit the sensor data received from the sensor unit 102 to the processor 134 or may perform interface processing to process the sensor data into a format readable by the processor 134. The interface circuit 132 may include multiple ports to assign a plurality of sensor data (e.g., front-camera frames, radar sweeps, or wheel-speed samples, etc.). In addition, the interface circuit 132 may include, for example, a component that converts sensor data assigned for each port into a transmission format or a read format (e.g., serialization, normalization, or packet framing, etc.). In this disclosure, interface processing may be referred to as interface IP processing for sensor data.

The processor 134 may include a first processor 136, a second processor 138, and a third processor 140 to execute preprocessing, perception processing, and control processing, and perform the above-described processing. The first processor 136 may include, for example, a Central Processing Unit (CPU) (e.g., multi-core CPUs or low-power CPUs, etc.). The second processor 138 may include, for example, a Neural Processing Unit (NPU) that executes a learning model related to at least object recognition. The third processor 140 may include, for example, a Graphical Processing Unit (GPU) that supports execution of the learning model (e.g., feature map processing or depth estimation tasks, etc.). In the present disclosure, the first processor 136 and the second processor 138 will be described, and a detailed description of the third processor 140 will be omitted.

The preprocessing is performed on the interface-processed sensor data, and may be performed, for example, by the first processor 136. The preprocessing may include, for example, noise removal, filtering, or clustering of the sensor data (e.g., Gaussian filtering, threshold-based denoising, or point clustering, etc.).

The perception processing uses a learning model to generate perception data from the preprocessed sensor data and may be performed, for example, by the second processor 138. The learning model may be constructed as a single deep learning model that receives all a plurality of sensor data, i.e., multimodal sensor data (e.g., camera–radar fusion, camera–lidar fusion, or multi-camera fusion, etc.). For example, the deep learning model may include a network model that performs object detection, semantic segmentation, depth estimation, and the like (e.g., YOLO-type detectors, encoder–decoder networks, or BEV-based inference, etc.). Perception data may be generated by inference from the network model described above.

The control processing may estimate a path based on the perception data, generate a control instruction based on the estimated path, and be performed, for example, by the first processor 136. The control command includes at least one of a longitudinal control and a lateral control and may be generated as a control signal of the actuator 114 (e.g., throttle request, brake torque, or steering-angle command, etc.). The control processing may be performed, for example, using a learning model for path estimation and generation of control commands (e.g., reinforcement-learning planners or trajectory-optimization networks, etc.).

The postprocessor 142 may process the perception data generated by the perception processing into a suitable format for the control processing or process the perception data into a format suitable for transmission for the control processing. The postprocessor 142 may include, for example, encoding, compressing, packetizing in a predetermined manner, etc. of perception data, and may be configured as a Digital Signal Processor (DSP) (e.g., fixed-point DSPs or SIMD-optimized processors, etc.). When the perception processing is performed by the second processor 138 configured with an NPU and the control processing is performed by the first processor 136 configured with a CPU, the postprocessor 142 may process the perception data into at least one of a transmission format suitable for transmission to the first processor 136 by the second processor 138 and a processing format for processing/reading by the first processor 136.

The scheduler 144 may perform scheduling of a plurality of sensor data in components involved in preprocessing, perception processing, postprocessing, and control processing. Specifically, the scheduler 144 may schedule the preprocessing so as to perform the preprocessing by asynchronously performing parallel processing the plurality of sensor data by the first processor 136 based on an order in which the interface-processed sensor data becomes available (e.g., earliest-completed frames or first-received data packets, etc.). The scheduler 144 may schedule the perception processing to asynchronously perform parallel processing the plurality of sensor data preprocessed by the second processor 138 to output the perception data for each sensor data (e.g., per-frame object lists or per-sensor segmentation outputs, etc.). In addition, the scheduler 144 may schedule postprocessing such that the perception data is asynchronously postprocessed in parallel by the postprocessor 142. The scheduler 144 may schedule the control process to perform the control process by synchronously processing the postprocessed perception data by the first processor 136 (e.g., synchronized trajectory evaluation or simultaneous update of control variables, etc.).

Parallel processing may mean that when a plurality of data passes through a series of a plurality of procedures (i.e., processes), a procedure that outputs the same result may process the plurality of data simultaneously, rather than sequentially processing each data (e.g., parallel frame filtering or batch-based inference, etc.). Synchronous processing or synchronous parallel processing may mean that, after processing of the plurality of data is fully completed in the preceding procedure, the plurality of processed data is simultaneously input and processed in the following procedure.

Asynchronous parallel processing may mean that, of a plurality of data in a preceding procedure, data for which processing is completed first is input to a following procedure, and then the completed data is input to the following procedure later than the pre-completed data (e.g., out-of-order frame delivery or staggered sensor updates, etc.). Asynchronous parallel processing may be performed when there is no dependency between units (e.g., frames) of the plurality of sensor data in at least some of the series of processing. That is, in processing of each sensor data, when synchronization with data processing of another sensor is required or time-series dependence is required, asynchronous parallel processing may not be executed.

The memory block 146 is the controller's storage and may have, for example, DRAM, ROM, flash memory as components (e.g., LPDDR modules, embedded flash, or non-volatile storage, etc.).

FIG. 4 shows an example of modules that configures a server.

The server 200 may transmit response data according to a request of the vehicle 100 to the vehicle 100, and also transmit an application embedded in the vehicle 100 and information for supporting vehicle driving to the vehicle 100 (e.g., map updates, driving-assistance modules, or diagnostic information, etc.). The server 200 may include a communication unit 202, a memory 204, and a processor 206.

The communication unit 202 may transmit and receive data to and from an external device, support mutual communication with the vehicle 100 in the present disclosure, and exchange data with the vehicle 100 (e.g., OTA firmware, traffic data, or feature-activation keys, etc.).

The memory 204 may store a program and various data for operating the server 200 and load the program or read and write the data at the request of the processor 206. The memory 204 may hold and manage a program for processing a request of the vehicle 100, an application embedded in the vehicle 100, and information for driving assistance (e.g., path-planning libraries, sensor-calibration files, or vehicle-usage logs, etc.).

The processor 206 may perform overall control of the server 200. The server 200 may be configured to execute programs and instructions stored in the memory 204. The processor 206 may execute the program to process and respond to the user's request transmitted from the vehicle 100 (e.g., route computation, hazard prediction, or service-authentication handling, etc.).

In the present disclosure, the processor 206 is illustrated as being configured as a single processing module. In another example, the processor 206 may be distributed into a plurality of processing modules, and the processing described above may be executed by a distributed processing model (e.g., cloud-edge split processing or load-balanced service clusters, etc.).

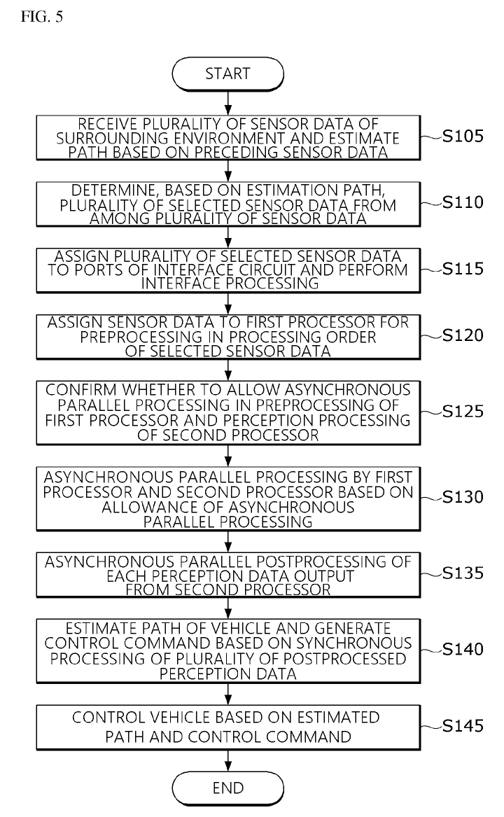

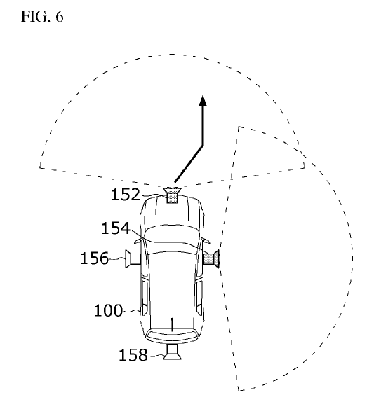

Hereinafter, a data scheduling method in a controller will be described in detail with reference to FIGS. 3 and 5. FIG. 5 shows an example of a data scheduling method.

Referring to S105 of FIG. 5, the controller 120 of the vehicle 100 may receive a plurality of sensor data from the sensor unit 102 that detects the surrounding environment, and estimate a path based on preceding sensor data (e.g., prior frame sequences, earlier radar sweeps, or previously sensed poses, etc.).

The plurality of sensor data may include, for example, a plurality of image data generated for each multi-camera. In another example, the plurality of sensor data may include image data of the camera 102a and heterogeneous data of a heterogeneous sensor. The heterogeneous sensor may be, for example, a radar sensor, or a lidar sensor (e.g., long-range radar, short-range radar, or 3D lidar, etc.).

The preceding sensor data may be sensor data acquired by the sensor unit 102 prior to the sensor data related to S105. An estimation path may be generated by a series of processes on the preceding sensor data, as described in FIG. 3. As another example, the estimation path may be predicted based on a control signal output to the preceding control process described in FIG. 3, a request signal of steering received from the operation unit 104, or an on signal of a direction indicator, such as a direction indicator light, received from the operation unit 104, and the like (e.g., turn-signal activation, sudden steering-angle change, or lane-change input, etc.).

Referring to S110 of FIG. 5, the controller 118 may determine, based on the estimation path, a plurality of selected sensor data from among the plurality of sensor data. The determination of the selected sensor data may be performed, for example, by the first processor 136 or the scheduler 144.

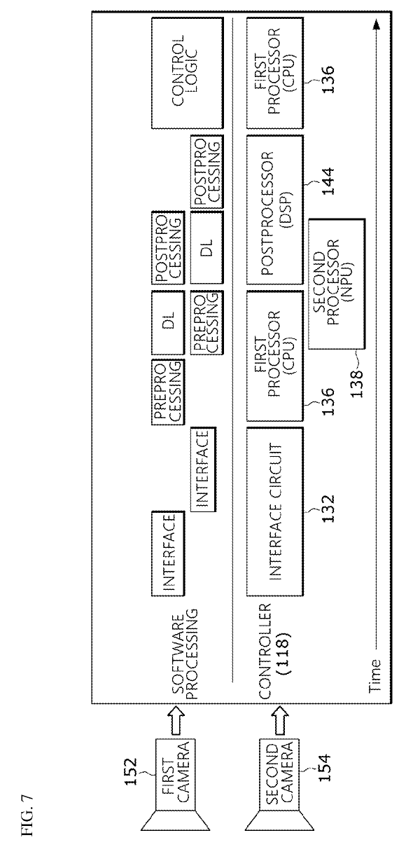

As illustrated in FIG. 6, when the estimation path is a right turn-back straight forward (see an arrow in FIG. 6) or a right cut-in for entering the right lane, sensor data (or image data) related to a front camera 152 and a right camera 154 among multi-cameras 152 to 158 may be determined as selected sensor data (e.g., right-front ROI, crosswalk-check region, or merge-lane monitoring region, etc.). FIG. 6 shows an example of sensor data selected based on an estimation path. In the case of driving along a straight line after turning right, the environment acquired by the front camera 152 and the right camera 154 may be more important than the left camera 156 and the rear camera 158.

In another example of S110, the controller 118 may distinguish higher priority sensor data and lower priority sensor data from the plurality of sensor data based on the estimation path. In the example of FIG. 6, sensor data of the front camera 152 and the right camera 154 may be determined as higher priority sensor data, and sensor data of the left camera 156 and the rear camera 158 may be determined as lower priority sensor data (e.g., deprioritized blind-spot views, rear-only coverage, or left-side peripheral images, etc.). According to this example, the lower priority sensor data may enter the interface processing in S115 during the preprocessing of the higher priority sensor data in S130, which will be described later.

Referring to S115 of FIG. 5, the scheduler 144 of the controller 118 assigns a plurality of selected sensor data to the ports of the interface circuit 132, and the interface circuit 132 may perform interface processing on the plurality of selected sensor data (e.g., per-port frame parsing, per-port packet formatting, or sensor-specific normalization, etc.).

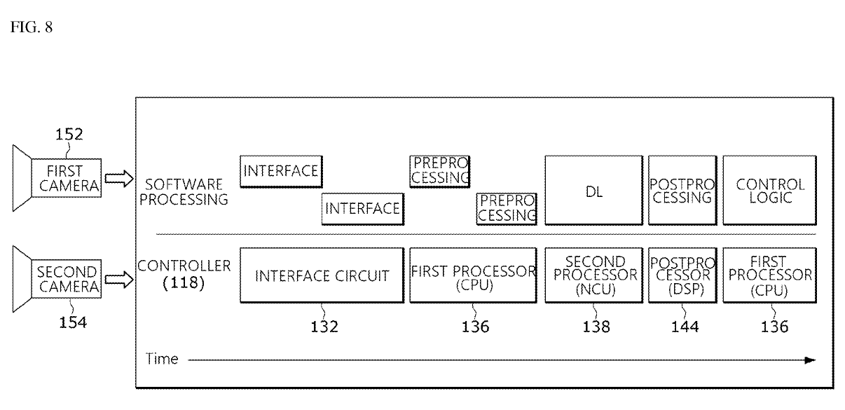

As illustrated in FIG. 7, according to an order in which a plurality of sensor data is input to the interface circuit 132, the interface circuit 132 may assign ports for each selected sensor data and perform interface processing from the first input sensor data. FIG. 7 shows an example of data processing according to data scheduling in the present disclosure. The interface circuit 132 may convert the selected sensor data assigned for each port into a transmission format or a read format. The description of the transmission format and the read format will be omitted as they are described in FIG. 3.

Referring to S120 of FIG. 5, the scheduler 144 may assign the selected sensor data to the first processor 136 for preprocessing in a processing order of the interface-processed selected sensor data. Since the output in the interface processing varies depending on the processing time and performance of the module for format processing per port, the assignment to the first processor 136 may proceed according to the processing order of the interface, rather than the input order of the selected sensor data, as illustrated in FIG. 7 (e.g., earliest-completed interface data, fastest-decoded frames, or lowest-latency port outputs, etc.).

Referring to S125 of FIG. 5, the controller 118 may confirm that the preprocessing of the first processor 136 and the perception processing of the second processor 138 allow asynchronous parallel processing for the plurality of selected sensor data (e.g., per-frame updates, per-sensor outputs, or staggered batches, etc.). That is, the controller 118 may determine whether to allow asynchronous parallel processing in the first processor 136 and the second processor 138. By identifying a process for which synchronous processing is required among a series of processes for the selected sensor data, a process for which asynchronous parallel processing is allowed may be identified (e.g., independent filtering steps, non-dependent inference cycles, or isolated postprocessing stages, etc.). The determination of the allowance of asynchronous parallel processing may be performed, for example, by the first processor 136 or the scheduler 144.

Referring to S130 of FIG. 5, the scheduler 144 may schedule, in the first processor 136, the preprocessing of the interface-processed selected sensor data to asynchronously parallel process the preprocessing in the first processor 136 based on the allowance of the asynchronous parallel processing. As illustrated in FIG. 7, the scheduler 144 may schedule the processing of the first processor 136 from the pre-finished selected sensor data to the post-finished selected sensor data for interface processing (e.g., earliest-ready interface output first, followed by later-ready outputs, etc.). The first processor 136 may preprocess the pre-finished selected sensor data first and preprocess the post-finished selected sensor data later according to scheduling. The preprocessing may include, for example, noise removal, filtering, or clustering of the sensor data (e.g., temporal denoising, edge-preserving filtering, or spatial clustering, etc.).

The scheduler 144 may schedule the perception processing of the preprocessed selected sensor data in the second processor 138 to asynchronously parallel process the perception processing in the second processor 138. As illustrated in FIG. 7, the scheduler 144 may schedule the perception processing to assign the preprocessed selected sensor data to the second processor 138 prior to outputting the preprocess-completed selected sensor data (e.g., immediate inference dispatch, early-batch submission, or rolling-window assignment, etc.). The perception processing may use a learning model to generate perception data from the preprocessed sensor data. The learning model is constructed as a single deep learning model that receives multimodal sensor data in an integrated manner, and the perception processing by the learning model is denoted as “DL” in FIG. 7 (e.g., BEV-based inference, fusion-based detection, or end-to-end perception networks, etc.).

Referring to S135 of FIG. 5, the scheduler 144 may schedule postprocessing of the plurality of perception data in the postprocessor 142 to asynchronously parallel process the postprocessing. As illustrated in FIG. 7, the scheduler 144 may schedule postprocessing to assign preceding perception data to the postprocessor 142 prior to generation of following perception data (e.g., first-ready inference outputs, partial frame sets, or prioritized packet groups, etc.). The postprocessor 142 may include, for example, encoding, compressing, packetizing in some manner, etc., of perception data (e.g., binary encoding, lightweight compression, or fixed format packetization, etc.).

Referring to S140 of FIG. 5, the scheduler 144 may schedule, in the first processor 136, a plurality of postprocessed perception data to perform synchronous parallel processing on the control processing. As illustrated in FIG. 7, the scheduler 144 may schedule the control process to simultaneously input the plurality of postprocessed perception data to the first processor 136 implementing the control logic (e.g., joint trajectory evaluation, batch control-policy updates, or unified command generation, etc.). The control process may include path estimation of the vehicle 100 and generation of control commands (e.g., steering-angle targets, speed targets, or lane-change decisions, etc.).

Referring to S145 of FIG. 5, the vehicle 100 may be controlled based on the estimated path and the control command (e.g., adjusting speed, steering toward the target lane, or executing a merge maneuver, etc.).

FIG. 8 shows an example of data processing according to synchronous scheduling of data. The synchronous scheduling is the same as the synchronous processing of the sensor data described in FIG. 3. According to the scheduling of FIG. 8, in order to synchronously process the learning model in the second processor 138, sensor data for which preprocessing has been completed must wait until preprocessing of all sensor data is completed (e.g., waiting for slowest sensor, finalizing all frames, or holding back early-ready outputs, etc.).

On the other hand, according to FIG. 7, the preprocessing, the perception processing, and the postprocessing are performed asynchronously for each of the plurality of sensor data, so that the end time until the postprocessing in FIG. 7 may be significantly shortened compared to FIG. 8. Accordingly, not only the delay time in the processing of the multimodal sensor data may be minimized, but also the occupancy of the second processor 138 corresponding to the NPU may be increased (e.g., higher utilization rate, reduced idle cycles, or increased inference throughput, etc.). In addition, not only the performance of the perception system as a whole is improved, but also the design cost is reduced through the improvement of the arithmetic performance, and the stability of the perception system may be ensured (e.g., improved real-time responsiveness, reduced hardware margin requirements, or enhanced fail-safe robustness, etc.).

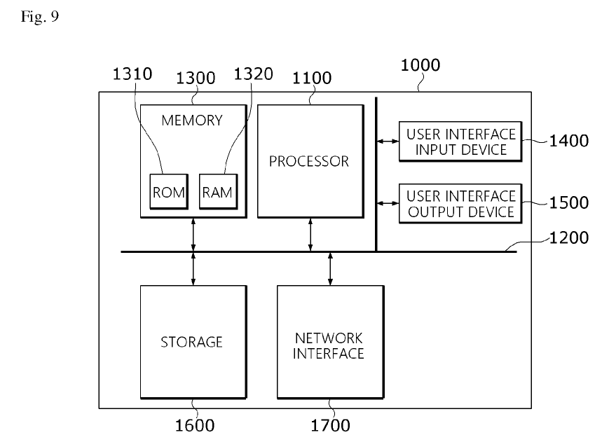

FIG. 9 shows an example computing system (e.g., a computing device of a vehicle or any other apparatus). One or more controllers, processors, etc. described herein, such as one or more components of the vehicle 100, one or more components of the server 200, one or more components of another vehicle 400, and any other components and devices disclosed herein, may be implemented by or in the computing system as shown in FIG. 9.

A computing system 1000 may include at least one processor 1100, memory 1300, a user interface input device 1400, a user interface output device 1500, a storage 1600, and a network interface 1700, which are connected with each other via a bus 1200. The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an example of the present disclosure, there is provided a data scheduling method, the method comprising: asynchronously performing parallel processing on a plurality of sensor data detected a surrounding environment of a vehicle by a first processor for preprocessing; asynchronously performing parallel processing on the plurality of preprocessed sensor data by a second processor for object recognition; and synchronously processing perception data output from the second processor.

For examples, the second processor may be configured to execute a learning model for performing object recognition.

For examples, the method may further comprise determining, before the asynchronous parallel processing by the first processor, whether to allow performing asynchronous parallel processing of the plurality of sensor data by the first processor and the second processor. The asynchronously performing parallel processing on a plurality of sensor data by a first processor may be performed based on the allowance of the asynchronous parallel processing.

For examples, the plurality of sensor data may comprise a plurality of image data generated for each multi-camera detecting the surrounding environment or comprise image data of a camera detecting the surrounding environment and heterogeneous data of a heterogeneous sensor. The heterogeneous sensor may detect the surrounding environment and is a different type of sensor from the camera.

For examples, the synchronously processing perception data may comprise synchronously processing the perception data to generate a path estimation and control command of the vehicle.

For examples, the synchronously processing perception data may be performed by the first processor.

For examples, the method may further comprise asynchronously performing parallel postprocessing, before the synchronously processing perception data, perception data output in parallel by the second processor.

For examples, the method may further comprise determining, before the asynchronous parallel processing by the first processor, selected sensor data from the plurality of sensor data by considering an estimated path of the vehicle based on preceding sensor data. The asynchronously performing parallel processing on a plurality of sensor data by a first processor may comprise asynchronously performing parallel processing the selected sensor data by the first processor.

For examples, , before the asynchronous parallel processing by the first processor, interface processing may be performed for each of the plurality of sensor data; and the asynchronously performing parallel processing on a plurality of sensor data by a first processor may comprise performing parallel processing the sensor data in an order of the interface processed sensor data by the first processor.

According to an example of the present disclosure, there is provided a vehicle, comprising: a plurality of sensors detecting a surrounding environment; a memory storing at least one instruction; and a controller including a first processor and a second processor that execute the at least one instruction stored in the memory and perform processing related to control of the vehicle. The controller is configured to: asynchronously perform parallel processing on a plurality of sensor data detected a surrounding environment of the vehicle by the first processor for preprocessing; asynchronously perform parallel processing on the plurality of preprocessed sensor data by the second processor for object recognition; and synchronously process perception data output from the second processor.

According to the present disclosure, it is possible to provide a data scheduling method and vehicle that improve processing performance of multimodal data and realize resource optimization.

The effects obtainable in the present disclosure are not limited to the effects mentioned above, and other effects not mentioned will be clearly understood by a person skilled in the art from the following description.

While the exemplary methods of the present disclosure described above are represented as a series of operations for clarity of description, it is not intended to limit the order in which the steps are performed, and the steps may be performed simultaneously or in different order as necessary. To implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by a vehicle, the method comprising:
obtaining, by a plurality of sensors of the vehicle, sensor data associated with a surrounding environment of the vehicle;
asynchronously performing parallel preprocessing on pieces of the sensor data;
asynchronously performing parallel object-recognition processing on the preprocessed pieces of the sensor data to generate perception data;
synchronously processing the perception data;
outputting a signal associated with the synchronously processed perception data; and
controlling, based on the signal, autonomous driving of the vehicle.

2. The method of claim 1, further comprising:
applying the preprocessed pieces of the sensor data to a trained learning model to perform the object recognition processing.

3. The method of claim 1, wherein the asynchronously performing parallel preprocessing on pieces of the sensor data comprises:
determining whether the preprocessing on the pieces of the sensor data allows asynchronous parallel execution, and
based on a determination that the preprocessing on the pieces of the sensor data allows asynchronous parallel execution, performing the asynchronous parallel preprocessing on the pieces of the sensor data.

4. The method of claim 1, wherein the plurality of sensors comprises at least a camera and a heterogeneous sensor different from the camera, and
wherein the sensor data comprises:
image data generated from the camera, and
heterogeneous data generated from the heterogeneous sensor.

5. The method of claim 1, wherein the synchronously processing perception data comprises synchronously processing the perception data to generate:
a path estimation associated with the vehicle, and
a control command for the vehicle.

6. The method of claim 5, wherein the synchronously processing perception data is performed by at least one first processor of the vehicle that performed the asynchronous parallel preprocessing, and
wherein the asynchronously performing parallel object-recognition processing is performed by at least one second processor of the vehicle.

7. The method of claim 1, further comprising:
before the synchronously processing perception data, asynchronously performing parallel postprocessing on the perception data.

8. The method of claim 1, further comprising:
before the asynchronous parallel processing, selecting the pieces of the sensor data, wherein the pieces of the sensor data are selected based on an estimated path of the vehicle, and wherein the estimated path is determined based on preceding sensor data of the plurality of sensors.

9. The method of claim 1, further comprising:
before the asynchronous parallel processing, performing interface processing on the pieces of the sensor data; and
performing parallel processing on the interface processed pieces of the sensor data.

10. A vehicle comprising:
a plurality of sensors configured to obtain sensor data associated with a surrounding environment of the vehicle; and
a memory storing at least one instruction that, when executed by at least one processor, is configured to cause the vehicle to:
asynchronously perform, using a first processor of the vehicle, parallel preprocessing on pieces of the sensor data,
asynchronously perform, using a second processor of the vehicle, parallel object-recognition processing on the preprocessed pieces of the sensor data to generate perception data,
synchronously process the perception data,
output a signal associated with the synchronously processed perception data, and
control, based on the signal, autonomous driving of the vehicle.

11. The vehicle of claim 10, wherein the at least one instruction, when executed by the at least one processor, is configured to cause the vehicle to execute a learning model for performing the object-recognition processing.

12. The vehicle of claim 10, wherein the at least one instruction, when executed by the at least one processor, is configured to cause the vehicle to:
determine whether the preprocessing on the pieces of the sensor data allows asynchronous parallel execution, and
based on a determination that the preprocessing on the pieces of the sensor data allows asynchronous parallel execution, perform the asynchronous parallel preprocessing on the pieces of the sensor data.

13. The vehicle of claim 10, wherein the plurality of sensors comprise at least a camera and a heterogeneous sensor different from the camera, wherein the sensor data comprises:
image data generated from the camera, and
heterogeneous data generated from the heterogeneous sensor.

14. The vehicle of claim 10, wherein the at least one instruction, when executed by the at least one processor, is configured to cause the vehicle to synchronously process the perception data to generate:
a path estimation associated with the vehicle, and
a control command for the vehicle.

15. The vehicle of claim 10, wherein the at least one instruction, when executed by the at least one processor, is configured to cause the vehicle to, before synchronously process the perception data, asynchronously perform parallel postprocessing on the perception data.

16. The vehicle of claim 10, wherein the at least one instruction, when executed by the at least one processor, is configured to cause the vehicle to, before asynchronously perform parallel preprocessing on the pieces of the sensor data, select the pieces of the sensor data, wherein the pieces of the sensor data are selected based on an estimated path of the vehicle, and wherein the estimated path is determined based on preceding sensor data of the plurality of sensors.

17. The vehicle of claim 10, wherein the at least one instruction, when executed by the at least one processor, is configured to cause the vehicle to:
before asynchronously perform parallel preprocessing, perform interface processing on the pieces of the sensor data, and
perform parallel processing on the interface processed pieces of the sensor data.

18. A vehicle comprising:
a plurality of sensors configured to obtain sensor data associated with a surrounding environment of the vehicle; and
a controller circuitry configured to cause the vehicle to:
estimate, based on the sensor data, a predicted driving path of the vehicle,
select, based on the estimated driving path, pieces of the sensor data,
schedule the selected pieces of the sensor data for earlier processing than remaining pieces of the sensor data,
process the selected pieces of the sensor data in parallel when processing of different pieces of the sensor data does not depend on one another,
output a signal indicating the processed pieces of the sensor data, and
control, based on the signal, autonomous driving of the vehicle.

19. The vehicle of claim 18, wherein the controller circuitry is further configured to schedule, based on an expected driving maneuver of the vehicle, the selected pieces of the sensor data for earlier processing.

20. The vehicle of claim 18, wherein the controller circuitry is further configured to schedule the selected pieces of the sensor data for earlier processing based on an order in which interface processing of the pieces of the sensor data is completed.
